(19) United States
(12) Patent Application Publication
(10) Pub. No.: US 2026/0220783 A1
(43) Pub. Date: Jul. 30, 2026

(54) Systems and Methods for Evolving Scenario-Agnostic Digital Twins

(71) Applicant: Samsung Electronics Company, Ltd., SUWON SI (KR)

(72) Inventor: Amrit Paul, Surrey (CA)

(21) Appl. No.: 19/038,255

(22) Filed: Jan. 27, 2025

(51) Int. Cl. G06T 7/12; G06V 10/74

(52) U.S. Cl. CPC G06T 7/12; G06V 10/761; G06T 2207/20081; G06T 2207/20084

(57) ABSTRACT

In one embodiment, a method includes accessing an image depicting a scene from a first sensor, constructing a semantic segmentation of the image including image segments for the scene based on the image, generating neural radiance fields based on the image segments, learning a graph neural network based on the neural radiance fields, constructing graph motifs based on sub-graphs associated with the graph neural network, wherein each graph motif functions as a graph-rule learner, generating a pre-trained digital twin based on the image segments and the graph-rule learners, generating semantic graph radiance fields based on sensor data from second sensors, the pre-trained digital twin, and the graph neural network, and generating a domain-specific digital twin based on the semantic graph radiance fields.

### TECHNICAL FIELD

This disclosure generally relates to digital twins, and in particular relates to hardware and software for evolving scenario-agnostic digital twins.

### BACKGROUND

Digital twins are virtual representations of our physical or real-world systems that can be interacted with and updated in real-time. Digital twins are often built by gathering sensory information and data aggregation, and finally recreating it in a digital space. In a digital twin, sensor information from the physical or real-world system is continuously gathered throughout different stages of the product lifecycle, such as, development, production, operation, and then fed to the digital twin model. Therefore, changes made in the real-world system are reflected in the digital twin. Digital twins are not limited by the constraints of our real-world systems. Instead, they provide scalable interactions in terms of digital twin scaling and the ability to perform downstream tasks, such as artificial-intelligence (AI) workflows, IoT data aggregation, etc. Digital twins are often constructed using multiple sensors, such as camera, LiDAR, IoT sensors, etc., and their applications can be seen in various fields such as automotive, manufacturing, healthcare, energy systems, etc. For example, consider the application of constructing a digital twin of an autonomous vehicle. Multiple sensors are used to capture the surrounding environment, and real-time data captured from the real-world system is continuously fed to the digital twin to simulate and generate multiple complex scenarios. A digital twin can be leveraged to demonstrate the outcomes of a scenario while a real-world system lacks such capability due to various hardware limitations as well as software incapabilities.

While digital twins help make complex, costly, and dangerous processes safer, affordable, and more achievable, they often pose several challenges. Firstly, high-fidelity sensors used to construct these complex virtual environments are very expensive and when used for applications requiring constrained resources, often are limited by their on-device processing. Moreover, the scalability of digital twins is limited due to the limitations of high-resolution environment details. Furthermore, the lack of standardized system for data integration possesses a challenge for data synchronization, although partially solved with deep neural networks (DNNs), however, lacking in data fidelity and quality. Non-evolving digital twins are a primary challenge, where the synthesized complex environment is not updated periodically with the changes in the physical environment of the real-world system and lack robustness in environment perturbations. Since most digital twins are constructed using labelled data, the cost of data annotation is also a challenge. Furthermore, once these data are labelled, the lack of domain-transfer capability of the digital twin which is to be used in other sub-systems also in an inherent issue in such sub-systems.

### BRIEF DESCRIPTION OF THE DRAWINGS

FIG. 1 illustrates an example system for evolving scenario-agnostic digital twins using mutual-information trees in semantic graph radiance fields.

FIG. 2 illustrates an example method diagram for evolving scenario-agnostic digital twins using mutual-information trees in semantic graph radiance fields.

FIGS. 3A-3B illustrate an example method diagram for iteratively using each segment to construct a neural radiance field across all scenes, as part of the iterative segmental radiance fields module 115.

FIG. 4 illustrates an example method diagram for learning a graph rule learner by using segments across all scenes, as part of the graph rule generator module.

FIG. 5 illustrates an example method diagram for generating a scene-agnostic pre-trained digital twin by using scene segments and graph rule learner, as part of the pre-trained digital twin module.

FIG. 6 illustrates an example method diagram for fusing the real environment and digital twin model by mutual information maximization using information trees, as part of the mutual information tree module.

FIGS. 7A-7B illustrate a flow diagram of a method for generating evolving scenario-agnostic digital twins, in accordance with the presently disclosed embodiments.

FIG. 8 illustrates an example computer system that may be utilized for determining sensing and communication precoders, in accordance with the presently disclosed embodiments.

### DESCRIPTION OF EXAMPLE EMBODIMENTS

### Generating Scenario-Agnostic Digital Twins

In particular embodiments, a computing system may incorporate the process of constructing a neural radiance field iteratively across all scenes and an attention-aware graph-rule learner from independent radiance fields. The computing system may further use the integrated process to generate a scene-agnostic pre-trained digital twin. Furthermore, the real-world system and digital twin models may be fused using mutual information maximization based on information trees, which is then used in semantic graph radiance fields for the generation of scene-aware digital twins. Digital twins may be generated from the semantic graph radiance fields by fusing multiple scenarios in each domain. The learnt digital twins may be sent to the control systems for further processing, such as scenario generation, system performance, system tuning, etc. Although this disclosure describes generating particular digital twins by particular systems in a particular manner, this disclosure contemplates generating any suitable digital twin by any suitable system in any suitable manner.

In particular embodiments, the computing system may access an image depicting a scene from a first sensor. The computing system may then construct, for the scene based on the image, a semantic segmentation of the image comprising a plurality of image segments. The computing system may generate a plurality of neural radiance fields based on the plurality of image segments. The computing system may further learn a graph neural network based on the plurality of neural radiance fields. The computing system may then construct one or more graph motifs based on one or more sub-graphs associated with the graph neural network, wherein each of the one or more graph motifs functions as a graph-rule learner. In particular embodiments, the computing system may generate a pre-trained digital twin based on the plurality of image segments and the one or more graph-rule learners. The computing system may then generate a plurality of semantic graph radiance fields based on sensor data from one or more second sensors, the pre-trained digital twin, and the graph neural network. The computing system may further generate a domain-specific digital twin based on the plurality of semantic graph radiance fields.

Certain technical challenges exist for generating evolving scenario-agnostic digital twins. One technical challenge may include relating visual reconstructions and semantic consistencies of the neural radiance fields. The solution presented by the embodiments disclosed herein to address this challenge may be using position and direction disentanglement vectors to learn attention-aware graph relationship between neural radiance fields and generate graph motifs as the position and direction disentanglement vectors may contain higher-dimensional latent representation of the neural radiance fields and the graph motifs can capture the graph embedding vectors and utilize graph attention. Another technical challenge may include generating a scene-agnostic pre-trained digital twin. The solution presented by the embodiments disclosed herein to address this challenge may be using mutual information maximization to train the scene-agnostic pre-trained digital twin by constructing multiple recursive information trees. Mutual information can facilitate the self-attention mechanism of the digital twin, which may also eliminate the use of additional classifiers or discriminator neural networks, whereas the use of recursive trees can ensure the contrastive loss behavior obtained from positive and negative samples.

Certain embodiments disclosed herein may provide one or more technical advantages. A technical advantage of the embodiments may include enabling the generated digital twins to evolve across applications and systems as the computing system may generate scene-aware semantic graph radiance fields which can ensure generalizability and robustness of the digital twins to environment perturbations across multiple applications, while preserving the evolving nature of digital twins, which can later be used in various system twins. Another technical advantage of the embodiments may include generalizability and robustness in digital twins while preserving the heuristic information of scenes, as a computing system may use semantic information of the surrounding environment to iteratively generate novel independent neural radiance fields from each segment of the scene. Another technical advantage of the embodiments may include generating fine-tuned digital twins from semantic graph radiance fields as the computing system may fuse multiple scenarios in each domain. Certain embodiments disclosed herein may provide none, some, or all of the above technical advantages. One or more other technical advantages may be readily apparent to one skilled in the art in view of the figures, descriptions, and claims of the present disclosure.

Digital twins are sophisticated virtual representations of the environment that leverages real-time data synchronization from the real-world system, also known as the physical system, facilitating enhanced operational efficiency, predictive maintenance, data-driven decisions, etc. In a digital twin, the real-world system may be digitally replicated to a complex virtual environment, that mirrors the behavior and characteristics of the real-world system. Environment sensors such as LiDAR, RGB cameras (stereo/mono), GPS/IMU, although not limited to the mentioned sensors, may be used to continuously feed real-time sensor data to update the state of the digital twin or complex virtual environment. Most of the digital twins constructed depending on the scenario/conditions of the real-world physical system may often impose constraints on the generalizability of such digital twins. Therefore, there is a need for a solution to generalize digital twins across diverse scenarios for a dynamically evolving twin.

In particular embodiments, the computing system may generate evolving scenario-agnostic digital twins using mutual-information trees in semantic graph radiance fields. The computing system may make use of images captured from the RGB (stereo/mono) sensors. The computing system may send the images to an environment scene module which uses semantic segmentation neural network to construct a semantic environment of the scene. As an example and not by way of limitation, the environment scene module may group multiple objects together, such as cars, pedestrians, road, traffic lights, traffic signs, etc. Each of these scenes may be then sent to an iterative segmental radiance fields module. The iterative segmental radiance fields module may construct neural radiance fields (NeRFs) for each segment iteratively by identifying grouped/associated sub-segments.

The scene correspondences across all scenes may be determined by using graph rule generator module, which encompasses various graph embeddings. These embeddings may be generated by disentangling position and direction features of the neural radiance fields. Furthermore, to associate the features across these embeddings, graph attention may be leveraged to determine embedding scores across all scenes.

A scene-agnostic pre-trained digital twin module may be then used to generate a digital twin by using the scene segments and graph rule learner. The semantic segmentation of the environment along with the pre-trained digital twin may be fused by using a mutual information tree module. The mutual information tree module may comprise multiple mutual information (MI) maximization trees. The mutual information trees may be further used to generate scene-aware semantic graph radiance fields by using environment sensors and scene correspondences in the pre-trained digital twin.

Finally, the MI based pre-trained digital twin, which uses graph rules to learn the associations of the environment and scene correspondences using mutual-information trees, can be used in several transferable domains. A system twin is an abstraction of a digital twin and represents how different components/assets work together. A fine-tuned digital twin module may be used to construct a system twin by combining the environment sensors which input real-time data to the MI based pre-trained digital twin. The control may be sent to the system twin for further processing such as scenario generation, system performance, system tuning, etc.

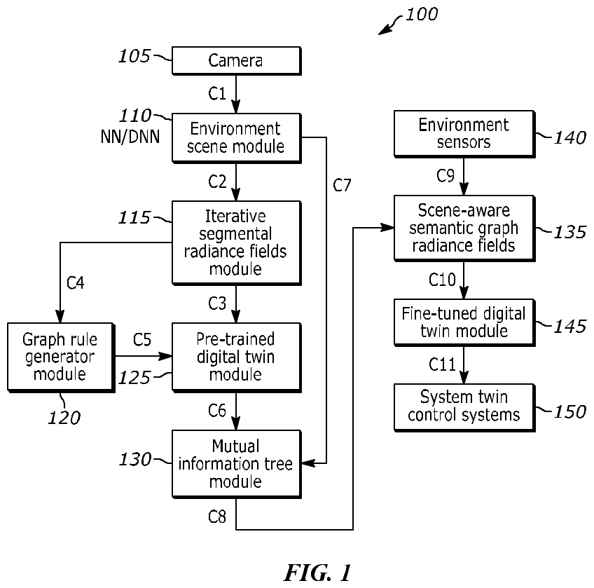

FIG. 1 illustrates an example system 100 for evolving scenario-agnostic digital twins using mutual-information trees in semantic graph radiance fields. The exemplary system 100 may include a camera sensor 105, an environment scene module 110, an iterative segmental radiance fields module 115, a graph rule generator module 120, a pre-trained digital twin module 125, a mutual information tree module 130, scene-aware semantic graph radiance fields 135, environment sensors 140, a fine-tuned digital twin module 145, and system twin control systems 150.

In the iterative segmental radiance fields module 115, neural radiance fields of each segment, which are captured from the semantic scene representation of the environment, may be constructed iteratively by identifying grouped sub-segments of the scene.

In the graph rule generator module 120, position/direction disentanglements may be used to construct graph motifs of the sub-segments containing higher-dimensional latent representation of the neural radiance fields. These motifs may capture the graph embedding vectors and later utilize graph attention to relate the visual reconstruction and semantic consistencies of the neural radiance fields.

In the pre-trained digital twin module 125, by combining the output of graph scene normalized (GSN) from the graph rule generator module 120 and semantic centroids from the iterative segmental radiance fields module 115, the scene-agnostic pre-trained digital twin may be generated. The generation of the scene-agnostic pre-trained digital twin may also utilize the mutual information between GSN and higher-dimensional latent representation from the graph rule generator module 120.

In the mutual information tree module 130, outputs from the pre-trained digital twin module 125 and the environment scene module 110 may be used to generate information trees and perform mutual information maximization, which is used in the optimization of generating a scene-agnostic pre-trained digital twin. Mutual information can facilitate the self-attention mechanism of the digital twin, which may also eliminate the use of additional classifiers or discriminator neural networks. Meanwhile, the use of recursive trees may ensure the contrastive loss behavior obtained from positive samples (denoted as Si) and from negative samples (denoted as Si).

In the scene-aware semantic graph radiance fields 135, through the joint optimization of loss function objective from the pre-trained digital twin module 125 and the mutual information tree module 130, the scene-aware semantic neural radiance fields may be generated. Furthermore, this optimization may lead to refined visual reconstruction to generate neural radiance fields while retaining semantic consistency between the graph motifs which contain higher-dimensional latent representation of radiance fields.

The fine-tuned digital twin module 145 may construct an optimized digital twin by combining the environment sensors. The environment sensors may input real-time sensor data to the MI-based pre-trained digital twin.

The exemplary system 100 may incorporate at least a processor and a memory which includes a volatile memory such as a random-access memory and a computer-readable medium or article. The memory may store a set of instructions or algorithms, which may be executed by the processor in accordance with the embodiments disclosed herein. Further, the connection interface denotes that the hardware and software-based modules of the exemplary system 100 are directly connected to or indirectly connected through one or more intermediate components. The exemplary system 100 may be implemented in a variety of miniature computing systems, such as robots, bots, autonomous vehicle or server, as well as not limited to the above environment sensors such as LiDAR, camera, GPS/IMU, radar, event driven sensors, etc. The exemplary system 100 can be adapted to exchange data with other components or service provider using a wide area network/internet. Possible systems on which the exemplary system 100 can be implemented include groups of automated guided vehicles (AGVs), autonomous vehicles, robots, or bots.

For readability, descriptions of connections/interfaces associated with various components of the system diagram and architecture are listed in Table 1 below.

TABLE 1
Connection/interface table with their descriptions illustrating
various components of the system diagram and architecture.

| Interface/Connection | Descriptions |
|---|---|
| “C1” | “C1” connector is used to send the RGB Camera (stereo/mono) images of the |
| | surrounding environment to Environment Scene Module for processing. |
| “C2” | “C2” connector is used to fetch scenes from the Environment Scene Module and |
| | iteratively construct neural radiance fields across all scenes. |
| “C3” | “C3” connector is used to capture the scene segments, specifically Semantic Centroids |
| | from the Iterative Segmental Radiance Fields Module. |
| “C4” | “C4” connector is used to learn graph rules using graph embeddings and graph motifs |
| | in the Graph Rule Generator Module. |
| “C5” | “C5” connector is used capture the graph rules and perform graph scene normalization |
| | to be processed by Pre-trained Digital Twin Module. |
| “C6” | “C6” connector is used to generate scene-agnostic pre-trained digital twin by using the |
| | outputs from Iterative Segmental Radiance Fields Module and Graph Rule Generator |
| | Module. The outputs are then fed to the Mutual Information Tree Module for further |
| | processing. |
| “C7” | “C7” connector is used to fetch the scenes from the Environment Scene Module which |
| | is further used by Mutual Information Tree Module for further processing. |
| “C8” | “C8” connector is used to fuse the semantic scenes from the Environment Scene Module |
| | and the scene-agnostic pre-trained digital twin of the Pre-trained Digital Twin Module |
| | by performing mutual information maximization using recursive information trees. The |
| | output is further optimized and sent to the Scene-Aware Semantic Graph Radiance |
| | Fields for further processing. |
| “C9” | “C9” connector is used to fetch the data from different sensors such as LiDAR, Radar, |
| | GPS/IMU, IoT Sensors, etc., which can be used to perform sensor fusion for data |
| | synchronization, if necessary, and then used to construct Scene-Aware Semantic Graph |
| | Radiance Fields. |
| “C10” | “C10” connector is used to generate Scene-Aware Semantic Graph Radiance Fields by |
| | using various Environment Sensors as well as the output from Mutual Information Tree |
| | Module. These radiance fields not only are scenario-agnostic in nature but also are |
| | generalizable digital twin representations of the physical system, within similar domains |
| | or fields of application. |
| “C11” | “C11” connector is used to generate fine-tuned digital twins with complex scenario |
| | generations using the Fine-tuned Digital Twin Module. Generation of complex |
| | scenarios which are generalizable across multiple domains or fields of application is |
| | possible, due to the nature of graph radiance fields, which have the properties of Position |
| | disentanglement and Direction disentanglement. |

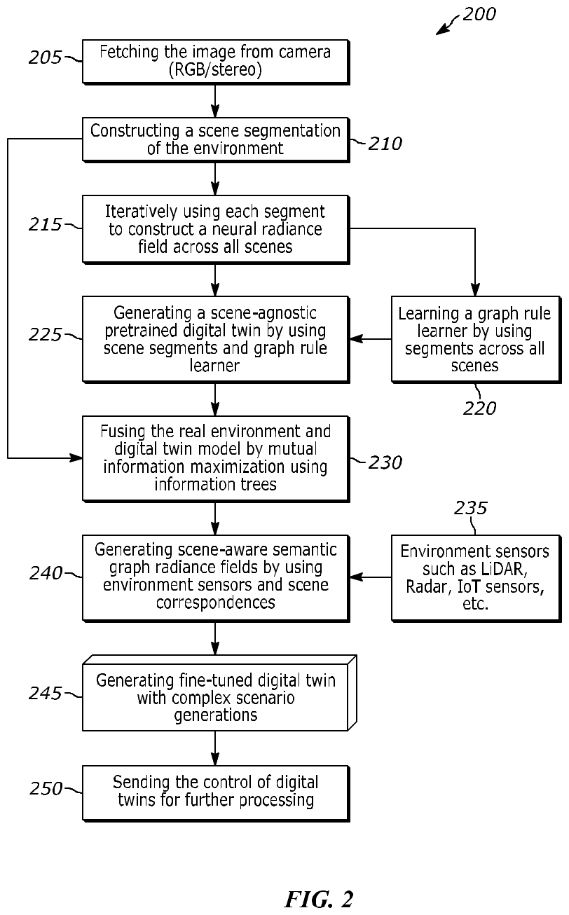

FIG. 2 illustrates an example method diagram 200 for evolving scenario-agnostic digital twins using mutual-information trees in semantic graph radiance fields. The method diagram 200 of system 100 may be executed by fetching the images from the camera sensors, either RGB stereo or mono images at step 205. At step 210, system 100 may construct semantic scene representation of the surrounding environment. Based on these scenes, neural radiance fields may be constructed iteratively by identifying the segments and sub-segments of a scene at step 215. Next at step 220, a graph rule learner may be learnt from the sub-segments of the scene along with the information of different neural radiance fields. The graph rule learner and the information of semantic centroids may be jointly used to generate a scene-agnostic pre-trained digital twin at step 225. Next at step 230, the information of the semantic environment is fused with the digital twin model by using information trees, specifically mutual information maximization. Fusion of such information may be required to learn the latent space information and domain mapping between different areas of applications. At step 235, additional sensory data from environment sensors such as LiDAR, radar, IoT sensors, etc., may be used in tandem with the information trees to generate scene-aware semantic graph radiance fields at step 240. At step 245, the optimization process of semantic graph radiance fields may lead to fine-tuned digital twins with complex scenario generations. At step 250, the control of these generated fine-tuned digital twins may be then sent for further processing, such as, scenario generation, system performance, system tuning, etc. Moreover, the embodiments disclosed herein may enable digital twin generalization across multiple domains and fields of applications. The embodiments disclosed herein may be also extendable and applicable in the field of distributed digital twins.

The details of the steps in the method diagram 200 are described below. In step 210 for constructing a scene segmentation of the environment, images captured from the camera sensor of the surrounding environment may be used to generate semantic scenes of the environment. The process to generate semantic scenes is called semantic segmentation, where multiple objects are grouped together such as people, cars, trucks, buildings, etc. A traditional approach of using computer vision can be used for this process. Alternatively, a deep neural network such as PSPNet or segment anything model (SAM) may be used to generate semantic scenes of the environment. Although this disclosure describes particular approaches for generating semantic scenes of the environment, this disclosure contemplates any suitable approach for generating semantic scenes of the environment.

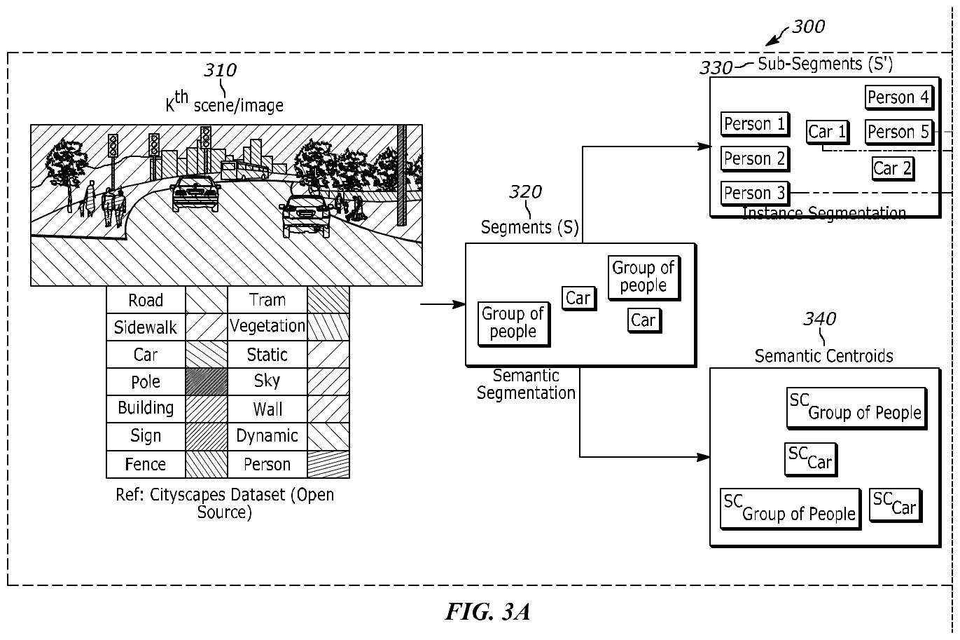

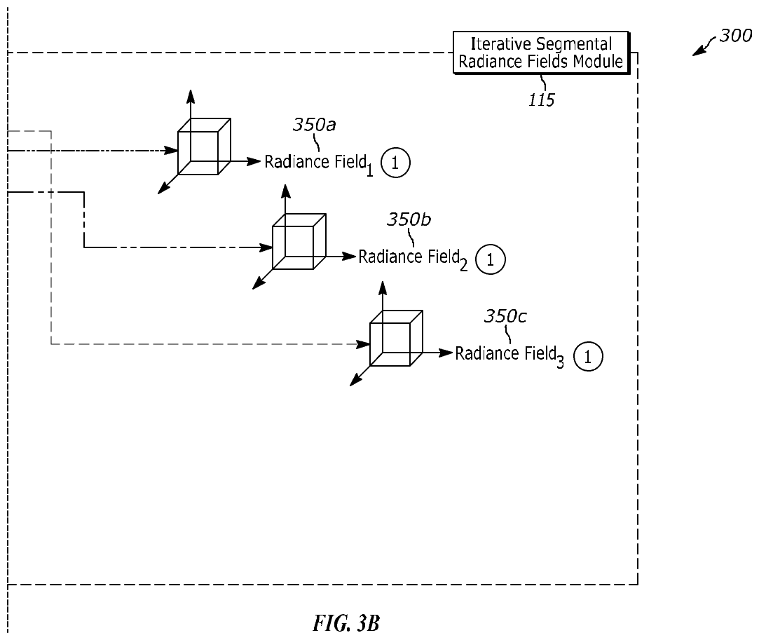

FIGS. 3A-3B illustrate an example method diagram 300 for iteratively using each segment to construct a neural radiance field across all scenes, as part of the iterative segmental radiance fields module 115. In this step, the semantic scenes (K) from the environment scene module 110 may be used, which generates multiple segments(S) 320 from each semantic scene (K^{th}) 310. Each segment 320 may include clustered objects like each other, which can be referred as the process of semantic segmentation. In particular embodiments, the system 100 may generate, for each of the image segments, one or more sub-segments of the respective image segment. The system 100 may identify each sub-segment (S′) 330 of a corresponding segment (which can be referred as the process of instance segmentation). In particular embodiments, the system 100 may determine a plurality of semantic centroids 340 associated with the plurality of image segments 320, respectively. In the process of generating a 3D representation of an object from its 2D image representation, the use of higher dimensional information may be importance. Thus, deep neural radiance fields may be used in this process to covert from image domain (2D) to a higher dimensional domain (3D). Furthermore, to determine positional, style or other latent contexts, deep neural radiance fields may be used to iteratively generate neural radiance fields 350 for each sub-segment, thereby, preserving the latent contexts as well as capturing each sub-segment with multiple dimensions-of-freedom, as shown in FIGS. 3A-3B. In particular embodiments, the system 100 may generate, for each sub-segment associated with each image segment, a respective neural radiance field. The plurality of neural radiance fields may include the respective neural radiance field corresponding to each sub-segment associated with each image segment. The embodiments disclosed herein may have a technical advantage of generalizability and robustness in digital twins while preserving the heuristic information of scenes, as a computing system may use semantic information of the surrounding environment to iteratively generate novel independent neural radiance fields from each segment of the scene.

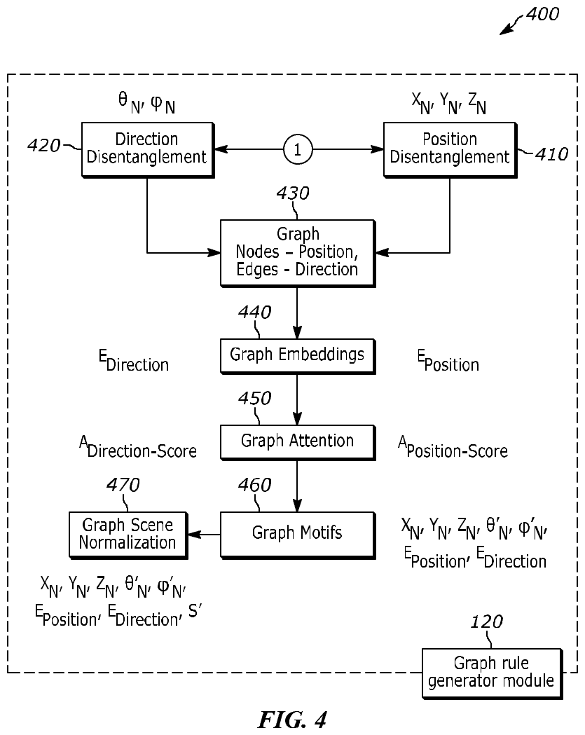

FIG. 4 illustrates an example method diagram 400 for learning a graph rule learner by using segments across all scenes, as part of the graph rule generator module 120. In this step, the output from the iterative segmental radiance fields module 115, specifically the 3D representations of deep neural radiance fields may be used. To generate the deep neural radiance fields from images, the position to be generated along camera rays as well as the direction of viewing along camera rays may be used for disentanglements of latent contexts. In particular embodiments, the system 100 may determine a respective position disentanglement and a respective direction disentanglement along each sub-segment.

The position disentanglement 410 along each sub-segment (X_{N}, Y_{N}, Z_{N},) and the direction disentanglement 420 along each sub-segment (θ_{N}, φ_{N}) may be used. X, Y, and Z correspond to the 3D positional representation learnt by the deep neural radiance field network along each axis. θ_{N}, φ_{N} correspond to the 3D directional representation learnt by the deep neural radiance field network along elevation and azimuth angle pairs. These representations may be used by deep neural radiance fields to construct the 3D representation including color (RGB) and volume density (ρ) after neural network optimization.

The position and direction disentanglements may be used to learn a graph neural network (GNN) 430 or a similar graph convolutional neural network (GCN) 430, based on the field of application. In other words, learning the graph neural network may be based on the respective position disentanglement and the respective direction disentanglement along each sub-segment. In particular embodiments, the graph neural network may include a plurality of graph node embeddings corresponding to the position disentanglements and a plurality of graph edge embeddings corresponding to the direction disentanglements. Each node of the graph 430 may correspond to the Nth position vector while each edge of the graph 430 may correspond to the N^{th} directional vector. Graph embeddings 440 may be determined from the nodes (E_{Position}) and edges (E_{Direction}) to embed higher-dimensional graph connections and activations from different graph nodes and edges. The graph embeddings 440 may contain trace activations from different nodes and edges with embedding vectors.

To determine attention 450 amongst graph embeddings, a graph attention mechanism may be used for every graph node embedding vector with respect to other graph node embeddings. In addition, corresponding graph attention scores may be calculated (A_{position-Score}). Similarly, the graph attention mechanism may be used for every graph edge node embedding vector with respect to other graph edge embeddings. In addition, corresponding graph attention scores may be calculated (A_{Direction-Score}). Based on the top-K graph attention scores, the system 100 may construct multiple graph motifs 460, which are sub-graphs generated from GNNs/GCNs. In particular embodiments, constructing the graph motifs may be based on the respective position disentanglement and the respective direction disentanglement along each sub-segment.

Using position and direction disentanglement vectors to learn attention-aware graph relationship between neural radiance fields and generate graph motifs may be an effective solution for addressing the technical challenge of relating visual reconstructions and semantic consistencies of the neural radiance fields as the position and direction disentanglement vectors may contain higher-dimensional latent representation of the neural radiance fields and the graph motifs can capture the graph embedding vectors and utilize graph attention.

Each sub-graph may act as a graph-rule learner, with a higher-dimensional latent vector representation X_{N}, Y_{N}, Z_{N}, θ′_{N}, φ′_{N}, E_{Position}, E_{Direction}. The spatial positional representations may be preserved by the GNNs/GCNs, while the new elevation and azimuth angles (θ′_{N}, φ′_{N}) may be learnt by the graph rule generator. Moreover, the top-K graph attention scores may be chosen (E_{Position}, E_{Direction}) and embedded in the latent representations of the graph motifs 460.

In particular embodiments, the system 100 may determine similarities between the sub-segments based on one or more distance metrics between the sub-segments. The system 100 may also determine structural similarities between the graph motifs 460 based on the one or more distance metrics between the graph motifs 460. The system 100 may further generate a normalized graph scene based on fusing the graph motifs 460 using the structural similarities between the graph motifs 460 and the similarities between the sub-segments. In other words, multiple sub-graphs or graph motifs 460 may be fused using structural similarity of motifs 460 as well as sub-segment similarities (S′) through the process of graph scene normalization 470, which leads to the final latent representation of dimension X_{N}, Y_{N}, Z_{N}, θ′_{N}, φ′_{N}, E_{Position}, E_{Direction}, S′, as shown in FIG. 4.

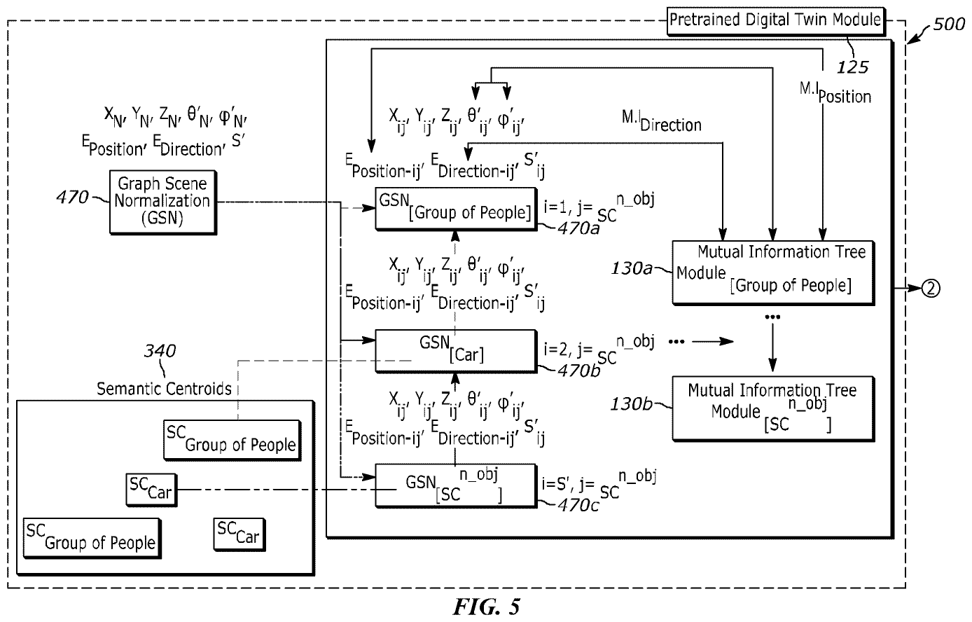

FIG. 5 illustrates an example method diagram 500 for generating a scene-agnostic pre-trained digital twin by using scene segments and graph rule learner, as part of the pre-trained digital twin module 125. In this step, the output from the iterative segmental radiance fields module 115, specifically semantic centroids (SC) 340 of the segments 320 and the output from the graph rule generator module 120, specifically graph scene normalization (GSN) 470 may be used. In particular embodiments, generating the pre-trained digital twin may be further based on the normalized graph scene and the plurality of semantic centroids 340.

To generate the scene-agnostic pre-trained digital twin, the joint vector representations of GSN 470 and SC 340 may be used such that for each segment of the semantic centroid 340, the GSN 470 may be multiplied. However, due to large dimensional representation, these feature vectors may be learnt by multiple small GNNs/GCNs. Each of these GNNs/GCNs (not illustrated in FIG. 5) may include the multiplications of GSN and SC vectors. This inherent property of multiplication may not only generate higher-order latent context representation but also bolster robustness and generalization of the pre-trained digital twin. Mathematically, this is shown as follows.

The hierarchical volume rendering to convert from 2D image to 3D deep neural radiance field may be formulated as

$${L}_{volume rendering} = {\sum }_{r ∈ R}^{n} {‖ C \hat{} ( r ) - C ( r ) ‖}^{2} .$$

Here, C\hat{ }(r) represents the approximation of the neural network to map to color and density and C(r) represents the approximation from the camera ray of position and direction. The scene-agnostic pre-trained digital twin may have the additional loss function using both GSN 470 and SC 340 for optimization, which may be formulated as below.

$${L}_{pre - trained digital twin} = {\sum }_{{S}^{′}} ( {X}_{N} , {Y}_{N} , {Z}_{N} , {θ}_{N}^{′} , {Φ}_{N} , {E}_{Position} , {E}_{Direction} ) \vert SC = {SC}_{n}^{o b j} = \qquad ( 1 )$$

$${\sum }_{i = 1}^{{S}^{′}} [ {\sum }_{i = 1}^{{SC}_{n}^{obj}} ( {( {x}_{i} )}_{j} , {( {y}_{i} )}_{j} , {( {z}_{i} )}_{j} , {( {Θ}_{i}^{′} )}_{j} , {( {Φ}_{i}^{′} )}_{j} , {( {E}_{Position} )}_{j} , {( {E}_{Direction} )}_{j} , ) ]$$

Equation (1) can be rewritten as a matrix representation below:

$$= [ \begin{matrix}{S}_{1} * [ {F}_{{SC}_{people}} \{ {x}_{j} , {y}_{j} , {z}_{j} , {Θ}_{j}^{′} , {Φ}_{j}^{′} , {{E}_{Position}}_{j} , {{E}_{Direction}}_{j} , {S}^{′} \} ] \\ {S}_{2} * [ {F}_{{SC}_{car}} \{ {x}_{j} , {y}_{j} , {z}_{j} , {Θ}_{j}^{′} , {Φ}_{j}^{′} , {{E}_{Position}}_{j} , {{E}_{Direction}}_{j} , {S}^{′} \} ] \\ {S}_{3} * [ {F}_{{SC}_{n}^{obj}} \{ {x}_{j} , {y}_{j} , {z}_{j} , {Θ}_{j}^{′} , {Φ}_{j}^{′} , {{E}_{Position}}_{j} , {{E}_{Direction}}_{j} , {S}^{′} \} ]\end{matrix} ]$$

Here, F_{SC} represents the small GNNs/GCNs, where the graph neural nets may be used to learn the feature vectors and there are S segments in the K^{th} scene/image. Therefore, the updated loss function in the method diagram 500 may be the summation of L_{volume rendering} and L_{pre-trained digital twin}. However, there may be a direct association of mutual information between θ′ⱼ, φ′ⱼ (direction vectors of the edges of the graph) to E_{Position} and a direction association of mutual information between θ′ⱼ, φ′ⱼ (direction vectors of the edges of the graph) to E_{Direction}. This inter-dependency with the respective sub-segments (S′), is shown in the mutual information tree module 130. Furthermore, in the matrix representation of Equation (1), the terms

$$[ {F}_{{SC}_{n}^{obj}} \{ {x}_{j} , {y}_{j} , {z}_{j} , {Θ}_{j}^{′} , {Φ}_{j}^{′} , {{E}_{Position}}_{j} , {{E}_{Direction}}_{j} , {S}^{′} \} ]$$

may be jointly optimized and the matrix represents the robust scene-agnostic pre-trained digital twin. FIG. 5 visually represents the above mathematical derivations with the inter-dependency of the mutual information tree module 130.

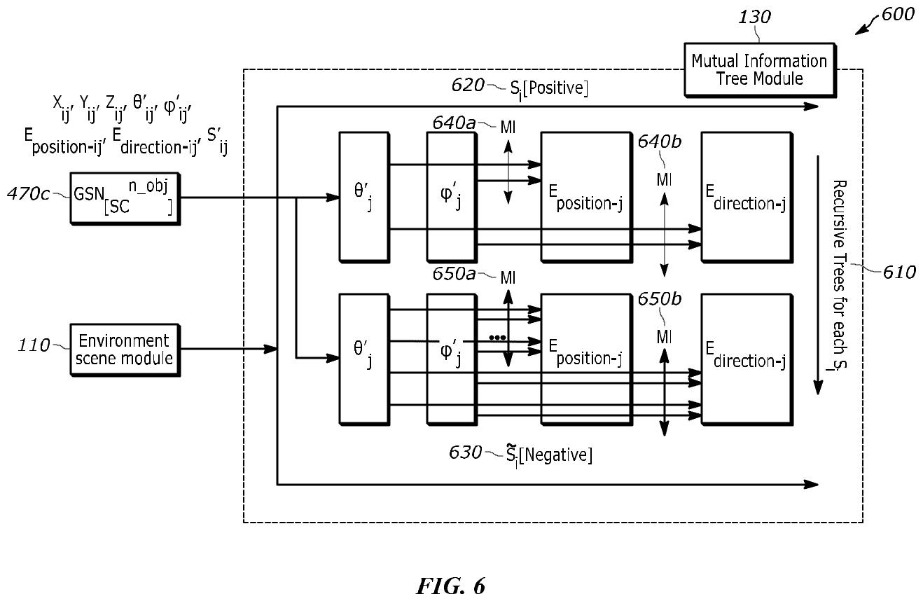

FIG. 6 illustrates an example method diagram 600 for fusing the real environment and digital twin model by mutual information maximization using information trees, as part of the mutual information tree module 130. In this step, the outputs from the pre-trained digital twin module 125 and the environment scene module 110 may be used to generate information trees and perform mutual information maximization, which may be used in the optimization of a scene-agnostic pre-trained digital twin. In particular embodiments, the system 100 may generate a plurality of recursive information trees based on the normalized graph scene, the semantic centroids, and the sub-segments. The generating of the recursive information trees may output mutual information between the graph node embeddings and mutual information between the graph edge embeddings. Accordingly, generating the pre-trained digital twin may be further based on the mutual information between the graph node embeddings and the mutual information between the graph edge embeddings.

Mutual information is the quantifying measure of amount of information captured by a node through the observation of other nodes. Formally, mutual information in graphs G(V, E) can be defined as

$$I ( {V}^{k} ) \approx I ( {V}^{k - 1} ) + {\sum }_{i = 1}^{N} ( {M}_{i}^{k - 1} ) .$$

The objective of mutual information maximization may be to maximize the agreement between positive node embeddings and global graph embeddings while minimizing the agreement between negative node embeddings and global graph embeddings.

One of the terms in the matrix representation of Equation (1) is

$$[ {F}_{{SC}_{n}^{obj}} \{ {x}_{j} , {y}_{j} , {z}_{j} , {θ}_{j}^{′} , {ϕ}_{j}^{′} , {{E}_{Position}}_{j} , {{E}_{Direction}}_{j} , {S}^{′} \} ] .$$

Based on information obtained from semantic centroids (SC) 340 and sub-segments (S′) 330, the system 100 may generate multiple recursive information trees 610 based on the number of segments(S) 320. Generating multiple recursive information trees 610 may facilitate the self-attention mechanism of the digital twin, which may also eliminate the use of additional classifiers or discriminator neural networks. For example, if K images are captured, then using the K^{th} scene, the system 100 can gather S segments 320. Furthermore, {xᵢⱼ, yᵢⱼ, zᵢⱼ, Θ′ᵢⱼ, Φ′ᵢⱼ, E_{Position}_{ᵢⱼ}, E_{Direction}_{ᵢⱼ},S′} may capture the higher-dimensional latent context vector, which may also capture the sub-segment information obtained from S′. The use of recursive trees 610 may also ensure the contrastive loss behavior which is obtained from positive samples (St) 620 and negative samples (Si) 630. Finally, the mathematical contribution of using deep neural radiance fields and learning the embeddings from position (xᵢⱼ, yᵢⱼ, zᵢⱼ), direction (θ′ᵢⱼ, φ′ᵢⱼ), graph nodes embeddings (E_{Position}_{ᵢⱼ}), graph edge embeddings (E_{Direction}_{ᵢⱼ}) and the neighboring sub-segments (S′) 330 may assist with mutual information maximization while recursively constructing information trees from segments(S) 320. In particular embodiments, the local and global asymptotic objective loss function during optimization of the pre-trained digital twin is shown as:

L_{mutual information maximization}

$$= - {\sum }_{i} log ( {F}_{{SC}_{j}^{{n}_{obj}}} \{ {x}_{ij} , {y}_{ij} , {z}_{ij} , {Θ}_{ij}^{′} , {Φ}_{ij}^{′} , {{E}_{Position}}_{ij} , {{E}_{Direction}}_{ij} , {S}^{′} \} , {S}_{i} ) \qquad ( 2 )$$

$$+ {\sum }_{i} log ( {F}_{{SC}_{j}^{n \_ obj}} \{ {x}_{ij} , {y}_{ij} , {z}_{ij} , {Θ}_{ij}^{′} , {Φ}_{ij}^{′} , {{E}_{Position}}_{ij} , {{E}_{Direction}}_{ij} , {S}^{′} \} , {\tilde{S}}_{i} )$$

In L_{mutual information maximization}, the first term represents the positive mutual information 640 while the second term represents negative mutual information 650. The first term may use the samples obtained from Sᵢ 620 and the second term may use the sample obtained from \tilde{S}ᵢ 630 to perform joint mutual optimization. FIG. 6 shows the positive mutual information and the negative mutual information based on the segments(S) 320 obtained from the environment scene module 110.

In particular embodiments, generating the plurality of semantic graph radiance fields may be further based on the mutual information between the graph node embeddings and the mutual information between the graph edge embeddings. In the step of generating scene-aware semantic graph radiance fields by using environment sensors and scene correspondences, the outputs from mutual-information (MI) trees based pre-trained digital twin may be used to generate scene-aware semantic graph deep neural radiance fields. Moreover, through the joint optimization of aggregated losses, i.e., L_{volume rendering}, L_{pre-trained digital twin} and L_{mutual information maximization}, the semantic graph radiance fields may be generated. The “semantic” spatial structure of the radiance fields may result in color and density estimation by the deep neural radiance fields. The graph rule leaners and MI based pre-trained digital twin optimization along with scene correspondences may result in “scene-aware” graph radiance fields. The nature of semantic and scene-aware radiance fields may ensure generalizability of the digital twins across multiple applications as well as evolving nature of digital twins. Furthermore, the usage of environment sensors may provide the real-time feedback mechanism to the digital twins to synthesize and simulate diverse constraints or scenarios, which can be later integrated in the real-world physical systems.

A technical advantage of the embodiments disclosed herein may include enabling the generated digital twins to evolve across applications and systems as the computing system may generate scene-aware semantic graph radiance fields which can ensure generalizability and robustness of the digital twins to environment perturbations across multiple applications, while preserving the evolving nature of digital twins, which can later be used in various system twins.

The final loss function which needs to be optimized (minimization) is given by:

$${L}_{final} = {L}_{volume rendering} + {L}_{pre - trained digital twin} + {L}_{mutual information maximization} = {{\sum }_{r ∈ R}}^{n} {‖ C \hat{} ( r ) - C ( r ) ‖}^{2} + {\sum }_{i = 1}^{{S}^{′}} [ {\sum }_{j = 1}^{{SC}_{n}^{obj}} ( {( {x}_{i} )}_{j} , {( {y}_{i} )}_{j} , {( {z}_{i} )}_{j} , {( {Θ}_{i}^{′} )}_{j} , {( {Φ}_{i}^{′} )}_{j} , {( {E}_{Position} )}_{j} , {( {E}_{Direction} )}_{j} , ) ] - {\sum }_{i} log ( {F}_{{SC}_{j}^{{n}_{obj}}} \{ {x}_{ij} , {y}_{ij} , {z}_{ij} , {Θ}_{ij}^{′} , {Φ}_{ij}^{′} , {{E}_{Position}}_{ij} , {{E}_{Direction}}_{ij} , {S}^{′} \} , {S}_{i} ) + {\sum }_{i} log ( {F}_{{SC}_{j}^{n \_ obj}} \{ {x}_{ij} , {y}_{ij} , {z}_{ij} , {Θ}_{ij}^{′} , {Φ}_{ij}^{′} , {{E}_{Position}}_{ij} , {{E}_{Direction}}_{ij} , {S}^{′} \} , {\tilde{S}}_{i} ) \qquad ( 3 )$$

The above loss function may be optimized to jointly train the scene-agnostic pre-trained digital twin model.

The first term corresponds to the hierarchical volume rendering loss while the second term corresponds to the matrix representation of the mutual information maximization of different samples (positive and negative) corresponding to the matrix representation in Equation (1). Also, the loss function may not only optimize over all the features (positive and negative) for a segment but also optimize across all the features (all segments) over all the scenes. This may ensure local and global asymptotic loss function optimization in the embodiments disclosed herein.

Using mutual information maximization to train the scene-agnostic pre-trained digital twin by constructing multiple recursive information trees may be an effective solution for addressing the technical challenge of generating a scene-agnostic pre-trained digital twin. Mutual information can facilitate the self-attention mechanism of the digital twin, which may also eliminate the use of additional classifiers or discriminator neural networks, whereas the use of recursive trees can ensure the contrastive loss behavior obtained from positive and negative samples.

In the step of generating fine-tuned digital twin with complex scenario generations, the fine-tuned digital twin module 145 may be used to construct an optimized digital twin by combining the environment sensors with the MI based pre-trained digital twin. The environment sensors may input real-time data to the MI based pre-trained digital twin. The pre-trained digital twin may be tuned to a particular domain of application. To preserve domain generalization in digital twins, the digital twin may be fine-tuned. The fine-tuning process can be implemented by further optimizing the pre-trained digital twin to new images and environment sensors, across all scenes. Finally, the fine-tuned digital twins can be used to synthesize complex scenarios by using the position and direction disentanglement embedding information captured from the camera rays and graph rule learners, and texture and density information obtained from the deep neural radiance fields. Moreover, the complex scenario may include various affine transformations of the radiance fields, style/geometry/appearance disentanglements, evolving nature of digital twins due to real-time environment sensor information, etc. As a result, the embodiments disclosed herein may have a technical advantage of generating fine-tuned digital twins from semantic graph radiance fields as the computing system may fuse multiple scenarios in each domain.

In particular embodiments, the system 100 may send the domain-specific digital twin to a system twin that models interactions and behavior of a complex system based on the scene corresponding to the domain-specific digital twin. The digital twin may be configured to be used by the system twin for executing a plurality tasks. As illustrated in FIG. 1, the system 100 may send the control of digital twins for further processing. A system twin is an abstraction of a digital twin. The system twin may represent how different components/assets work together. The fine-tuned digital twin may be then used within a system twin and the control may be further sent to the system control for further processing, such as scenario generation within system twins, system performance, system tuning, etc.

The following describes the diverse metrics used to assess the performance of the overall system (digital twin), as summarized by their system modules.

For the iterative segmental radiance fields module 115, to evaluate the performance of semantic segmentation and instance segmentation, the neural networks can be individually or jointly trained based on the metric of mean intersection over union (mIoU) over the dataset. Traditionally, a pre-trained semantic/instance segmentation neural network can be used for this task. However, to train the neural radiance fields, apart from using traditional metrics such as PSNR (peak signal-to-noise ratio) which determines the quality of the reconstructed scene (higher is better), metrics including LPIPS (learned perceptual image patch similarity) which measures the similarity by comparing deep embedding features from a neural network may be used. In addition, advanced metrics such as Frechet inception distances (FID) which measures the distances between distributions of real and synthetic images and Chamfer distance (CD) which measures distribution similarity may be used.

For the graph rule generator module 120, to measure the performance of graph motif construction using unsupervised approach, GED (graph edit distance) can be used to compare the similarity of the generated graph to the reference graph of a trained graph neural network over a dataset of samples. GED may ensure that fewer number of graph transformations (additions/removal) are needed for a higher similarity index. Moreover, a clustering coefficient can be used which measures the heuristic representations of graph nodes which have positive associations closer and negative association farther from each other. Subsequently, a graph motif frequency counting approach can also be used to count the common structure representations of similar objects, indicating a low graph motif distribution, which shows a high graph-rule consistency and capture of higher-level latent representation in the graph.

For the pre-trained digital twin module 125, in the optimization of the loss function (L_{pre-trained digital twin}) represented from the matrix representation in Equation (1), FSC may be the small GNNs/GCNs. The graph neural nets may be used to learn the feature vectors and there may be S segments in the K^{th} scene/image.

For the mutual information tree module 130, the optimization of the loss function (L_{mutual information maximization}) may include learning the embeddings from position (xᵢⱼ, yᵢⱼ, zᵢⱼ), direction (Θ′ᵢⱼ, Φ′ᵢⱼ), graph nodes embeddings (Eₚₒₛᵢₜᵢₒₙ), graph edge embeddings (E_{Direction}) and the neighboring sub-segments (S′) with mutual information maximization while recursively constructing information trees from segments(S).

For the scene-aware semantic graph radiance fields 135, the joint optimization of the matrix representation of the loss function (L_{final}) may ensure the semantic-geometric consistency in the semantic neural graph radiance fields. The consistency score may be measured between the semantic boundary to the geometric overlap of the reconstruction. Furthermore, advanced IoU metrics such as boundary IoU can be used, which are traditionally used in semantic neural radiance fields. The joint loss may not only optimize over all the features (positive and negative) for a segment but also optimize across all the features (all segments) over all the scenes, ensuring local and global asymptotic loss function optimization.

For the fine-tuned digital twin module 145, based on the corresponding field of application, the number of unique segments from the scenes can be trained and optimized for a digital twin, which may result in a fine-tuned digital twin. Furthermore, the pre-trained digital twin can be used across different applications, which may provide domain-transfer capability-generalizability, as well as robustness to environment perturbations. In addition, communication between digital twins can be established for a corresponding system twin.

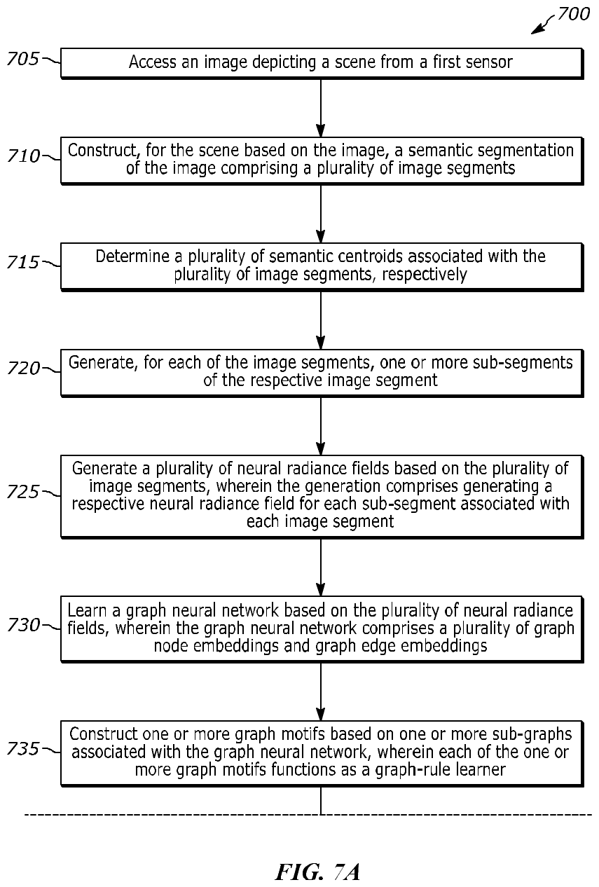

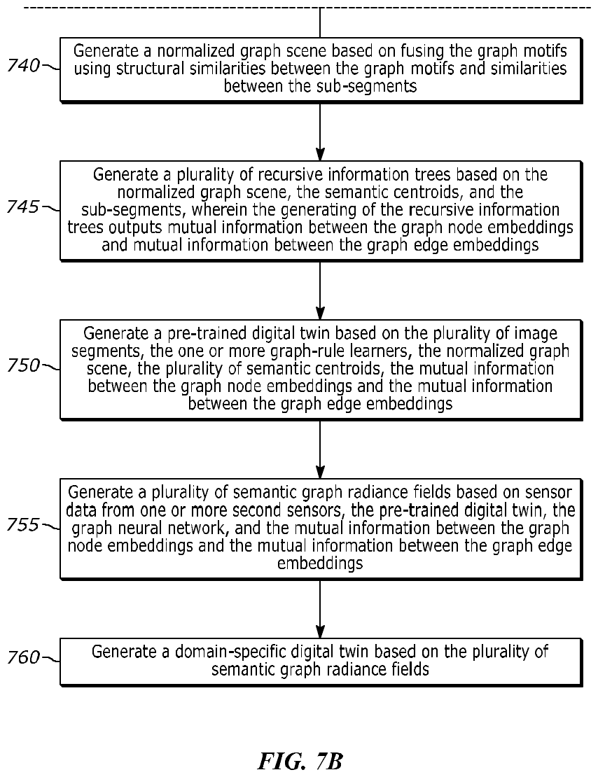

FIGS. 7A-7B illustrate a flow diagram of a method 700 for generating evolving scenario-agnostic digital twins, in accordance with the presently disclosed embodiments. The method 700 may be performed utilizing one or more processing devices (e.g., a computing system) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing wireless communication data, software (e.g., instructions running/executing on one or more processors), firmware (e.g., microcode), or some combination thereof.

The method 700 may begin at step 705 with the one or more processing devices (e.g., the computing system). For example, in particular embodiments, the computing system may access an image depicting a scene from a first sensor. The method 700 may then continue at step 710 with the one or more processing devices (e.g., the computing system). For example, in particular embodiments, the computing system may construct, for the scene based on the image, a semantic segmentation of the image comprising a plurality of image segments. The method 700 may then continue at step 715 with the one or more processing devices (e.g., the computing system). For example, in particular embodiments, the computing system may determine a plurality of semantic centroids associated with the plurality of image segments, respectively. The method 700 may then continue at step 720 with the one or more processing devices (e.g., the computing system). For example, in particular embodiments, the computing system may generate, for each of the image segments, one or more sub-segments of the respective image segment. The method 700 may then continue at step 725 with the one or more processing devices (e.g., the computing system). For example, in particular embodiments, the computing system may generate a plurality of neural radiance fields based on the plurality of image segments, wherein the generation comprises generating a respective neural radiance field for each sub-segment associated with each image segment. The method 700 may then continue at step 730 with the one or more processing devices (e.g., the computing system). For example, in particular embodiments, the computing system may learn a graph neural network based on the plurality of neural radiance fields, wherein the graph neural network comprises a plurality of graph node embeddings and graph edge embeddings. The method 700 may then continue at step 735 with the one or more processing devices (e.g., the computing system). For example, in particular embodiments, the computing system may construct one or more graph motifs based on one or more sub-graphs associated with the graph neural network, wherein each of the one or more graph motifs functions as a graph-rule learner. The method 700 may then continue at step 740 with the one or more processing devices (e.g., the computing system). For example, in particular embodiments, the computing system may generate a normalized graph scene based on fusing the graph motifs using structural similarities between the graph motifs and similarities between the sub-segments. The method 700 may then continue at step 745 with the one or more processing devices (e.g., the computing system). For example, in particular embodiments, the computing system may generate a plurality of recursive information trees based on the normalized graph scene, the semantic centroids, and the sub-segments, wherein the generating of the recursive information trees outputs mutual information between the graph node embeddings and mutual information between the graph edge embeddings. The method 700 may then continue at step 750 with the one or more processing devices (e.g., the computing system). For example, in particular embodiments, the computing system may generate a pre-trained digital twin based on the plurality of image segments, the one or more graph-rule learners, the normalized graph scene, the plurality of semantic centroids, the mutual information between the graph node embeddings and the mutual information between the graph edge embeddings. The method 700 may then continue at step 755 with the one or more processing devices (e.g., the computing system). For example, in particular embodiments, the computing system may generate a plurality of semantic graph radiance fields based on sensor data from one or more second sensors, the pre-trained digital twin, the graph neural network, and the mutual information between the graph node embeddings and the mutual information between the graph edge embeddings. The method 700 may then continue at step 760 with the one or more processing devices (e.g., the computing system). For example, in particular embodiments, the computing system may generate a domain-specific digital twin based on the plurality of semantic graph radiance fields. Particular embodiments may repeat one or more steps of the method of FIGS. 7A-7B, where appropriate. Although this disclosure describes and illustrates particular steps of the method of FIGS. 7A-7B as occurring in a particular order, this disclosure contemplates any suitable steps of the method of FIGS. 7A-7B occurring in any suitable order. Moreover, although this disclosure describes and illustrates an example method for generating evolving scenario-agnostic digital twins including the particular steps of the method of FIGS. 7A-7B, this disclosure contemplates any suitable method for generating evolving scenario-agnostic digital twins including any suitable steps, which may include all, some, or none of the steps of the method of FIGS. 7A-7B, where appropriate. Furthermore, although this disclosure describes and illustrates particular components, devices, or systems carrying out particular steps of the method of FIGS. 7A-7B, this disclosure contemplates any suitable combination of any suitable components, devices, or systems carrying out any suitable steps of the method of FIGS. 7A-7B.

### Systems and Methods

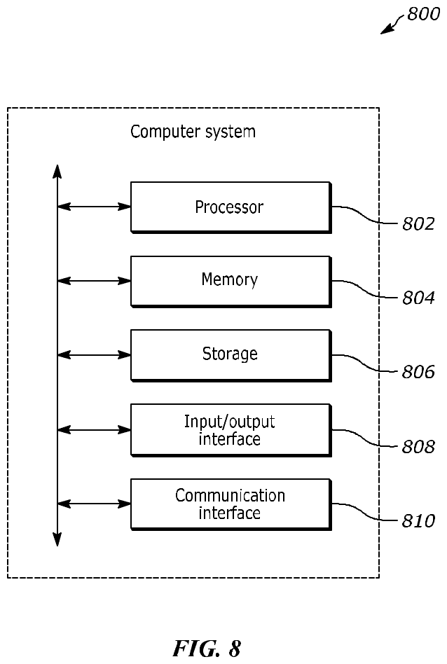

FIG. 8 illustrates an example computer system 800 that may be utilized for determining sensing and communication precoders, in accordance with the presently disclosed embodiments. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks.

Where appropriate, one or more computer systems 800 may perform without substantial spatial or temporal limitation one or more steps of one or more methods described or illustrated herein. As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement. In particular embodiments, processor 802 includes hardware for executing instructions, such as those making up a computer program. As an example, and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802.

Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example, and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere).

One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memory devices, where appropriate. Although this disclosure describes and illustrates particular memory, this disclosure contemplates any suitable memory.

In particular embodiments, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it.

As an example, and not by way of limitation, computer system 800 may communicate with an ad hoc network, a personal area network (PAN), a local area network (LAN), a wide area network (WAN), a metropolitan area network (MAN), an ultra-wideband network (UWB), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example, and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing an image depicting a scene from a first sensor;
constructing, for the scene based on the image, a semantic segmentation of the image comprising a plurality of image segments;
generating a plurality of neural radiance fields based on the plurality of image segments;
learning a graph neural network based on the plurality of neural radiance fields;
constructing one or more graph motifs based on one or more sub-graphs associated with the graph neural network, wherein each of the one or more graph motifs functions as a graph-rule learner;
generating a pre-trained digital twin based on the plurality of image segments and the one or more graph-rule learners;
generating a plurality of semantic graph radiance fields based on sensor data from one or more second sensors, the pre-trained digital twin, and the graph neural network; and
generating a domain-specific digital twin based on the plurality of semantic graph radiance fields.

2. The method of claim 1, further comprising:
generating, for each of the image segments, one or more sub-segments of the respective image segment; and
generating, for each sub-segment associated with each image segment, a respective neural radiance field;
wherein the plurality of neural radiance fields comprise the respective neural radiance field corresponding to each sub-segment associated with each image segment.

3. The method of claim 2, further comprising:
determining a respective position disentanglement and a respective direction disentanglement along each sub-segment, wherein learning the graph neural network and constructing the graph motifs are based on the respective position disentanglement and the respective direction disentanglement along each sub-segment, and wherein the graph neural network comprises a plurality of graph node embeddings corresponding to the position disentanglements and a plurality of graph edge embeddings corresponding to the direction disentanglements.

4. The method of claim 3, further comprising:
determining similarities between the sub-segments based on one or more distance metrics between the sub-segments;
determining structural similarities between the graph motifs based on the one or more distance metrics between the graph motifs; and
generating a normalized graph scene based on fusing the graph motifs using the structural similarities between the graph motifs and the similarities between the sub-segments.

5. The method of claim 4, further comprising:
determining a plurality of semantic centroids associated with the plurality of image segments, respectively; and
generating the pre-trained digital twin further based on the normalized graph scene and the plurality of semantic centroids.

6. The method of claim 5, further comprising:
generating a plurality of recursive information trees based on the normalized graph scene, the semantic centroids, and the sub-segments,
wherein the generating of the recursive information trees outputs mutual information between the graph node embeddings and mutual information between the graph edge embeddings, and
wherein generating the pre-trained digital twin is further based on the mutual information between the graph node embeddings and the mutual information between the graph edge embeddings.

7. The method of claim 6, wherein generating the plurality of semantic graph radiance fields is further based on the mutual information between the graph node embeddings and the mutual information between the graph edge embeddings.

8. The method of claim 1, further comprising:
sending the domain-specific digital twin to a system twin that models interactions and behavior of a complex system based on the scene corresponding to the domain-specific digital twin, wherein the digital twin is configured to be used by the system twin for executing a plurality tasks.

9. A computing system comprising:
one or more non-transitory computer-readable storage media including instructions; and
one or more processors coupled to the storage media, the one or more processors configured to execute the instructions to:
access an image depicting a scene from a first sensor;
construct, for the scene based on the image, a semantic segmentation of the image comprising a plurality of image segments;
generate a plurality of neural radiance fields based on the plurality of image segments;
learn a graph neural network based on the plurality of neural radiance fields;
construct one or more graph motifs based on one or more sub-graphs associated with the graph neural network, wherein each of the one or more graph motifs functions as a graph-rule learner;
generate a pre-trained digital twin based on the plurality of image segments and the one or more graph-rule learners;
generate a plurality of semantic graph radiance fields based on sensor data from one or more second sensors, the pre-trained digital twin, and the graph neural network; and
generate a domain-specific digital twin based on the plurality of semantic graph radiance fields.

10. The system of claim 9, wherein the processors are further operable when executing the instructions to:
generate, for each of the image segments, one or more sub-segments of the respective image segment; and
generate, for each sub-segment associated with each image segment, a respective neural radiance field;
wherein the plurality of neural radiance fields comprise the respective neural radiance field corresponding to each sub-segment associated with each image segment.

11. The system of claim 10, wherein the processors are further operable when executing the instructions to:
determine a respective position disentanglement and a respective direction disentanglement along each sub-segment, wherein learning the graph neural network and constructing the graph motifs are based on the respective position disentanglement and the respective direction disentanglement along each sub-segment, and wherein the graph neural network comprises a plurality of graph node embeddings corresponding to the position disentanglements and a plurality of graph edge embeddings corresponding to the direction disentanglements.

12. The system of claim 11, wherein the processors are further operable when executing the instructions to:
determine similarities between the sub-segments based on one or more distance metrics between the sub-segments;
determine structural similarities between the graph motifs based on the one or more distance metrics between the graph motifs; and
generate a normalized graph scene based on fusing the graph motifs using the structural similarities between the graph motifs and the similarities between the sub-segments.

13. The system of claim 12, wherein the processors are further operable when executing the instructions to:
determine a plurality of semantic centroids associated with the plurality of image segments, respectively; and
generate the pre-trained digital twin further based on the normalized graph scene and the plurality of semantic centroids.

14. The system of claim 13, wherein the processors are further operable when executing the instructions to:
generate a plurality of recursive information trees based on the normalized graph scene, the semantic centroids, and the sub-segments,
wherein the generating of the recursive information trees outputs mutual information between the graph node embeddings and mutual information between the graph edge embeddings, and
wherein generating the pre-trained digital twin is further based on the mutual information between the graph node embeddings and the mutual information between the graph edge embeddings.

15. The system of claim 14, wherein generating the plurality of semantic graph radiance fields is further based on the mutual information between the graph node embeddings and the mutual information between the graph edge embeddings.

16. A computer-readable non-transitory storage media comprising instructions executable by a processor associated with a computing system to:
access an image depicting a scene from a first sensor;
construct, for the scene based on the image, a semantic segmentation of the image comprising a plurality of image segments;
generate a plurality of neural radiance fields based on the plurality of image segments;
learn a graph neural network based on the plurality of neural radiance fields;
construct one or more graph motifs based on one or more sub-graphs associated with the graph neural network, wherein each of the one or more graph motifs functions as a graph-rule learner;
generate a pre-trained digital twin based on the plurality of image segments and the one or more graph-rule learners;
generate a plurality of semantic graph radiance fields based on sensor data from one or more second sensors, the pre-trained digital twin, and the graph neural network; and
generate a domain-specific digital twin based on the plurality of semantic graph radiance fields.

17. The media of claim 16, wherein the software is further operable when executed to:
generate, for each of the image segments, one or more sub-segments of the respective image segment; and
generate, for each sub-segment associated with each image segment, a respective neural radiance field;
wherein the plurality of neural radiance fields comprise the respective neural radiance field corresponding to each sub-segment associated with each image segment.

18. The media of claim 17, wherein the software is further operable when executed to:
determine a respective position disentanglement and a respective direction disentanglement along each sub-segment, wherein learning the graph neural network and constructing the graph motifs are based on the respective position disentanglement and the respective direction disentanglement along each sub-segment, and wherein the graph neural network comprises a plurality of graph node embeddings corresponding to the position disentanglements and a plurality of graph edge embeddings corresponding to the direction disentanglements.

19. The media of claim 18, wherein the software is further operable when executed to:
determine similarities between the sub-segments based on one or more distance metrics between the sub-segments;
determine structural similarities between the graph motifs based on the one or more distance metrics between the graph motifs; and
generate a normalized graph scene based on fusing the graph motifs using the structural similarities between the graph motifs and the similarities between the sub-segments.

20. The media of claim 19, wherein the software is further operable when executed to:
determine a plurality of semantic centroids associated with the plurality of image segments, respectively; and
generate the pre-trained digital twin further based on the normalized graph scene and the plurality of semantic centroids.
